(19) United States
(12) Patent Application Publication
(10) Pub. No.: US 2014/0278759 A1
(43) Pub. Date: Sep. 18, 2014

(54) SYSTEMS AND METHODS FOR LEAD DEVELOPMENT IN A BUSINESS TO BUSINESS MARKETPLACE

(71) Applicants: Damon Lawson, Stillwater, MN (US); Mark Galloway, Eagan, MN (US)

(72) Inventors: Damon Lawson, Stillwater, MN (US); Mark Galloway, Eagan, MN (US)

(21) Appl. No.: 14/210,597

(22) Filed: Mar. 14, 2014

Related U.S. Application Data
(60) Provisional application No. 61/792,686, filed on Mar. 15, 2013.

(51) Int. Cl. G06Q 30/02

(52) U.S. Cl. CPC G06Q 30/0201
USPC 705/7.29

(57) ABSTRACT

A combination of personal contact, digital tools, and focused means of communication to improve customer interaction, resulting in effective lead generation, nurturing, and development. The various embodiments of the present disclosure leverage hardware and software components in order to automate various aspects of lead capturing and nurturing processes based on a predetermined sequence of actions or steps and a set of predetermined rules with the purpose of triaging initial leads and identifying the “right” contacts who influence or impact the purchasing decisions, and routing of the triaged leads for follow-up and on-going managed pursuit involving various means of communication.

### CROSS-REFERENCE TO RELATED APPLICATIONS

The present application claims the benefit of U.S. Prov. Appl. No. 61/792,686, titled “Systems and Methods for Lead Nurturing in a Business to Business Marketplace,” filed Mar. 15, 2013, which is hereby incorporated by reference herein in its entirety.

### FIELD OF THE INVENTION

The present disclosure relates to systems and methods for facilitating the pursuit of marketing leads in a business-to-business marketplace in order to increase the number of sales opportunities. Particularly, the present disclosure relates to systems and methods for capturing marketing leads and tracking the pursuit and progress of turning them into sales opportunities, and for nurturing the leads along the way, in order to effectively drive up sales.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A business-to-business (B2B) market is a market involving commerce transactions between businesses or companies, such as those transactions between a manufacturer and a wholesaler or between a wholesaler and a retailer, as opposed to those transactions between a business or company and a consumer. The volume of B2B transactions has grown substantially as businesses utilize more and more online marketing tactics to generate interest in their products and solutions.

However, the B2B market has changed, and B2B buyers are ever more often leveraging their consumer buying habits for their B2B purchasing efforts. For example, where a B2B buyer may have traditionally been required to call a sales line or fill out a “contact us” form in order to alert a company to its interest, that same B2B buyer now has a vast array of tools at their disposal, and the ability and know-how to use such tools, to seek out and make decisions about its purchases without ever alerting vendors as to its interest.

Accordingly, there is a need in the art for more effective ways to generate and develop marketing leads into sales opportunities in a B2B market, or in any market, including business-to-consumer markets for that matter. More particularly, there is a need for better systems and methods for capturing leads and tracking the pursuit and progress of turning them into sales opportunities, and for developing the leads along the way, in order to effectively drive up sales.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a combination of personal contact, digital tools, and focused means of communication to improve customer interaction, resulting in effective lead generation, nurturing, and development. At a general level, the various embodiments of the present disclosure leverage hardware and software components in order to automate various aspects of lead capturing and development processes based on a predetermined sequence of actions or steps and a set of predetermined rules with the purpose of triaging initial leads and identifying the “right” contacts who influence or impact the purchasing decisions, and routing of the triaged leads for follow-up and on-going managed pursuit involving various means of communication. If initial pursuits fail to generate sales opportunities, the various embodiments may route such leads into a unique lead nurturing system or workflow in order to further nurture and develop the leads into sales opportunities.

The present disclosure, in another embodiment, relates to a method for capturing and developing marketing leads. The method may include storing, in a computer-readable storage medium, an addressable market definition comprising a definition for a desirable account type and/or a definition for a desirable contact type, and storing, in a computer-readable storage medium, an account pursuit rule defining an action to be pursued for a marketing lead. With an electronic processor having access to the computer-readable storage medium, the addressable market definition is automatically applied to a given lead during a triage process to determine whether the lead falls within the addressable market definition, and where the lead falls within the addressable market definition, the lead may be routed to an active pursuit process. The active pursuit process may include placing marketing leads in an automatically controlled communication cycle queue, the controlled communication cycle queue acting in accordance with a predetermined plan of lead pursuit and driving when communication attempts should be made to the marketing leads. A desirable account type may be defined by one or more attributes characterizing a desirable account. Likewise, a desirable contact type may be defined by one or more attributes characterizing a contact person as a desirable contact. One attribute characterizing a contact person as a desirable contact could be, for example, the contact person's employee role within a company. In some embodiments, the lead may be a raw lead derived from higher level hand-raising activity of the raw lead, such as the raw lead's viewing of a website or portion thereof and/or the raw lead's viewing or electronic download of multimedia content. In additional embodiments, where the lead does not fall within the addressable market definition, the lead may be routed to a lead optimization process for determining additional information about the lead. Additional information about the lead may be derived from one or more web-accessible databases. The lead, with additional information, may be routed to the active pursuit process. In one embodiment, the automatically controlled communication cycle queue may drive communication attempts through a combination of communication means, such as one or more telephone communications and email communications. Typically, the automatically controlled communication cycle queue may last for a predetermined period of time. In still further embodiments, a digital multimedia element may be included or incorporated in at least one of the communications. The digital multimedia element may be selected from a library of digital multimedia content, and the selection of the digital multimedia element may be based on which lead the digital multimedia element is to be sent. In yet another embodiment, at or after the conclusion of the predetermined period of time of the automatically controlled communication cycle, the lead may be routed to a nurturing campaign comprising placing the lead in a predefined queue, the predefined queue defined by a lead characteristic with which at least one attribute of the lead corresponds. A predefined queue may be an at least partly automated communication queue that sends an automatic communication to the lead. In some embodiments, the electronic processor may automatically track historical interactions with the lead and provide an electronic report based on the tracked historical interactions.

The present disclosure, in still another embodiment, relates to a system for capturing and developing marketing leads. The system may include a computer-readable storage medium storing an addressable market definition defining one or more attributes for a desirable marketing lead type and storing an account pursuit rule defining an action to be pursued for a given marketing lead. The system may also include an electronic processor communicatively coupled with the computer-readable storage medium, the electronic processor applying the addressable market definition to a given lead during a triage process to determine whether the lead falls within the addressable market definition, and where the lead falls within the addressable market definition, routing the lead to an active pursuit process comprising placing marketing leads in an automatically controlled communication cycle queue, the controlled communication cycle queue acting in accordance with a predetermined plan of lead pursuit and driving when communication attempts should be made to the marketing leads. The system may further include a user interface, provided by the electronic processor, and configured for display on an electronic display communicatively coupled with the electronic processor via an electronic network. The automatically controlled communication cycle queue may drive communication attempts through a combination of communication means. Furthermore, the automatically controlled communication cycle queue may last for a predetermined period of time. In some embodiments, at least one of the communications may include or incorporate a digital multimedia element, wherein the digital multimedia element is selected from a library of digital multimedia content, the selection of the digital multimedia element based on which marketing lead the digital multimedia element is to be sent. In a further embodiment, at or after the conclusion of the predetermined period of time, the electronic processor may route the lead to a predefined queue. The predefined queue may be defined by a lead characteristic with which at least one attribute of the lead corresponds and may be an at least partly automated communication queue that sends an automatic communication to the lead.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic illustration of a system and method for capturing and nurturing market leads in accordance with one embodiment of the present disclosure.

FIG. 2 is a schematic illustration of a TAM definition structure.

FIG. 3 is a flow diagram for triage and account pursuit analysis processes in accordance with one embodiment of the present disclosure.

FIG. 4 is a schematic illustration of a lead optimization process in accordance with one embodiment of the present disclosure.

FIG. 5 is a schematic illustration of moment of interest marketing in accordance with one embodiment of the present disclosure.

FIG. 6 is a schematic illustration of active pursuit in accordance with one embodiment of the present disclosure.

FIG. 7 is a schematic illustration of a MQL pass-back system or method in accordance with one embodiment of the present disclosure.

FIGS. 8A-8E are illustrations of various front-end facing interfaces for interacting with the automated flow a system and method for capturing and nurturing market leads in accordance with one embodiment of the present disclosure.

### DETAILED DESCRIPTION

The present disclosure relates to novel and advantageous systems and methods for facilitating the pursuit of marketing leads in a B2B marketplace in order to increase the number of sales opportunities. Particularly, the present disclosure relates to novel and advantageous systems and methods for capturing marketing leads and tracking the pursuit and progress of turning them into sales opportunities, and for nurturing the leads along the way, in order to effectively drive up sales.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. A system may include random access memory (RAM), one or more processing resources such as a central processing unit (CPU) or hardware or software control logic, ROM, and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor or flat-screen display, a printer, and speakers or any device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information.

Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. A code segment of the computer-executable program code may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, wireline, optical fiber cable, radio frequency (RF) signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the C programming language or similar programming languages.

Various embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As recognized above, there is a need in the art for generating and nurturing marketing leads into sales opportunity, and particularly in a B2B market since the volume of B2B transactions has grown substantially as businesses utilize more and more online marketing tactics to generate interest in their products and solutions. The present disclosure provides improvements in the systems and methods for turning marketing leads into sales opportunities. In general, the present disclosure describes systems and methods for capturing leads and tracking the pursuit and progress of turning them into sales opportunities, and for nurturing the leads along the way, in order to effectively drive up sales. The various embodiments described herein combine personal contact, digital tools, and focused means of communication to improve customer interaction, resulting in effective lead generation and nurturing. In this regard, the various embodiments of the present disclosure are additionally designed to improve the effectiveness of converting raw marketing leads at a “contact” level, where the initial lead may have no direct impact on the purchasing decisions, into sales-ready opportunities at an “account” level, where the lead has developed into one or more contacts with influence or impact on the purchasing decisions.

At a general level, the various embodiments of the present disclosure leverage system components, such as those hardware and software components detailed above, in order to automate various aspects of the lead capturing and nurturing processes based on a predetermined sequence of actions or steps and a set of predetermined rules with the purpose of triaging initial leads and identifying the “right” contacts who influence or impact the purchasing decisions, and routing of the triaged leads for follow-up and on-going managed pursuit involving various means of communication. If initial pursuits fail to generate sales opportunities, the various embodiments may route such leads into a unique lead nurturing system or workflow in order to further nurture the leads into sales opportunities. If further nurturing fails to be fruitful, the lead may be routed to a lead reconstitution system or workflow, where the lead may generally be put into general marketing databases available for future lead generation campaigns. During such lead generation campaigns, the lead may again become responsive and may be re-routed to the lead development and pursuit workflows described herein.

FIG. 1 provides a diagrammatic or schematic overview of one embodiment of a system and method for capturing and developing market leads 100 of the present disclosure, employable by a user company to effectively turn its marketing leads into sales opportunities. As part of the system and method for capturing and developing market leads 100, a definition for the total addressable market (TAM) of the user company may be defined. A TAM definition of the present disclosure may generally define those account or contact types that would generally be in potential need for the products and/or services offered by the user of the system or method of the present disclosure. The TAM account or contact types may be defined by one or more attributes that characterize the desired accounts and contacts. The TAM definition may be stored in a TAM definition database 102. The TAM definition for each user or user company may be defined by that user or user company, and the TAM definition may vary from user (or user company) to user (or user company). Each user or user company may define the TAM as broadly or narrowly as desired based on, for example, which leads that user or user company considers valuable.

For example, as illustrated in FIG. 2, which diagrammatically illustrates a TAM definition structure 200, a TAM definition database 102 for a user company may comprise one or more account definitions 204 and/or one or more contact definitions 206 for accounts and/or clients generally falling with the user company's TAM. An account definition 204 may be defined by one or more attributes 208 that characterize an account as one potentially falling within the TAM for the user company. Any suitable combination of attributes selected from a plurality of possible attributes may be utilized in order to compile an account definition. Possible attributes include, but are not limited to, the industry of the potential account, the size of the account, the location of the account, the type of account, the potential sale volume, or any other suitable attribute commonly or uncommonly utilized to characterize a company, and those illustrated in FIG. 2 are but some examples and are but one suitable combination of attributes. Likewise, a contact definition 206 may be defined by one or more attributes or role types 210 that characterize a contact as one potentially falling within the TAM for the user company or as having influence or impact on the purchasing decisions of a potential account. Any suitable combination of attributes and/or role types selected from a plurality of possible attributes and role types may be utilized in order to compile a contact definition. Possible attributes and/or role types include, but are not limited to, categorizations as an economic decision maker, such as a CEO, President, CFO, or the like, a technology decision maker, such as a CIO or technology director/manager, a process owner, such as an operations director/manager, or an end user, such as non-managing staff, or any other suitable employee categorization or employee role commonly or uncommonly utilized to characterize an employee's responsibilities and influence in decision making, and those illustrated in FIG. 2 are but some examples. A contact definition 206 may be relationally linked with an account definition 204. The account definitions 204 and contact definitions 206 may be stored in the TAM definition database 102.

With reference back to FIG. 1, the TAM definitions, via the defined account and contact definition attributes, may drive a triage process 104 for identifying the “right” contacts who influence or impact the purchasing decisions. The triage process 104, more specifically, may validate raw leads 106 against the TAM definition, e.g., against the account definitions and/or the contact definitions. Essentially, the triage process 104 and the TAM definition database 102 work cooperatively to determine whether any given raw lead should “pass” triage and move into a more active lead pursuit or nurturing process. Raw leads 106 may come from any number of sources or be obtained in any number of manners, including but not limited to random or solicited inbound connections, perhaps via the Internet or telephone call, for example. In some embodiments, raw leads 106 may be derived from user high level “hand-raising” activities, such as but not limited to, a user's visit to a website or a particular portion or page thereof, a user's download from a website of a whitepaper, audio, video, or other multimedia content; a user's viewing of a video or other multimedia content while at a website, etc. Such activities may generally be low-quality, as they will likely include users and contacts that are not relevant and/or do not influence or impact purchasing decisions.

Leads that pass triage may then be acted on according to a set of predetermined account pursuit rules 108. As illustrated in FIG. 2, a TAM definition structure 200 may further include one or more of such account pursuit rules 108, stored in the TAM definition database 102, or other database. An account pursuit rule 108 may include an applied account definition 212 defining which account or contact types on which the pursuit rule may be applied and/or defining which triage results cause the account pursuit rule to be applied. The applied account definition 212 may be defined by attributes similar to those utilized for an account definition 204 and/or any other factors, such as factors based on potential triage results. That is, any suitable combination of attributes selected from a plurality of possible attributes may be utilized in order to compile an applied account definition. Possible attributes include, but are not limited to, the industry of the potential account, the size of the account, the location of the account, the type of account, the potential sale volume, or any other suitable attribute commonly or uncommonly utilized to characterize a company, and those illustrated in FIG. 2 are but some examples and are but one suitable combination of attributes. Each account pursuit rule 108 may further include a set of action rules 214 defining what action is to be pursued for an account falling within the applied account definition 212. Any suitable action or combination of actions selected from a plurality of possible actions may be utilized in order to define a course of action to be performed for a given lead passing the triage process 104. Generally, as a result of the triage process 104, TAM definition, and/or application of account pursuit rules 108, certain raw leads may be automatically qualified (referred to as “Automated Qualified Leads” (AQLs)) and routed to one of a number of different lead nurturing and/or development paths.

In some embodiments, based on the TAM definition, one or more outbound lead generation campaigns 110 may be initiated. Such campaigns may involve any number of marketing methods, but may be particularly focused on marketing to existing or known leads already predetermined to fall within the TAM definition, and thus, any leads generating from responders to the marketing efforts may skip the triage process 104, as illustrated in FIG. 1.

In one embodiment, the triage process and the account pursuit rules may work cooperatively to determine the next action to be pursued for any given lead, including raw leads 106 or leads coming from outbound lead generation campaigns 110. FIG. 3 illustrates a flow process for one embodiment 300 of the triage and account pursuit analysis processes. At step 302, a raw lead 106 or other lead may initiate the triage process 104. During the triage process, the raw lead 106 may be subjected to a variety of tests to determine the potential for lead. For example, in step 304, it may be determined whether the lead has unsubscribed. If the lead has unsubscribed, then one or more account pursuit rules 108 may define that the database entry for that lead be updated to reflect the status of the lead, in step 306, and the lead be sent to a lead optimization process, in step 308, which will be discussed in further detail below. In step 310, it may be determined whether the lead has requested not to be called. If the lead has made such request, then one or more account pursuit rules 108 may define that the database entry for that lead be updated to reflect the status of the lead, in step 312, and the lead be sent to a lead optimization process, in step 314. In step 316, it may be determined whether the lead was simply a false positive, for example, being a lead that passed triage but shouldn't have. If the lead has been categorized as a false positive, then account pursuit rules 108 may define that the database entry for that lead be updated to reflect the status of the lead, in step 318, and the lead be nonetheless sent to a lead optimization process, in step 320. In step 322, it may be determined whether the lead fits one or more account or contact definitions in the TAM definition database 102. If the lead does not fit within a TAM definition, then account pursuit rules 108 may define that the database entry for that lead be updated to reflect the status of the lead, in step 324, and the lead be sent to a lead optimization process, in step 326. If the lead otherwise “passes” triage, account pursuit rules 108 may define that the lead be sent to a particular lead pursuit effort, in step 328. In one embodiment, an available lead pursuit effort may be referred to herein as moment of interest marketing 114 (FIG. 1), which will be described in further detail below, and which may generally be used to connect with the lead at a time that may be relatively better for turning the lead into a valuable contact. However, other lead pursuit efforts may be utilized, and the present disclosure is not limited to only the example lead pursuit effort described herein.

With reference back to FIG. 1, and as described above, certain leads may be sent to a lead optimization process 112. The lead optimization process may operate to add value to or optimize the lead with additional information about the account or contact, which may be pulled from a variety of readily-available resources. In one embodiment, illustrated schematically in FIG. 4, a lead optimization process 400 may generally determine whether the lead is associated with the appropriate buyer's journey roles. Buyer's journey roles may be those various roles or steps a buyer takes on in pursuit of a purchasing solution, for example, from discovery and research, to evaluation, and on to making purchasing decisions. In one embodiment, an initial step 402 of lead optimization 400 may include identifying whether there are missing buying journal roles for the lead. The lead optimization process may, in some embodiments, be configured with a profile of business roles conventionally expected to have some or increased influence or impact on the buyer's purchase decisions. In step 404, lead optimization 400 may employ readily available research tools 406, such as but not limited to, free or subscription web-available applications or services like LinkedIn, Dunn & Bradstreet, InsideView, Google, or the like. In some embodiments, the optimization may be automated, for example, through the use of web crawlers or other automated research tools. Any information discovered through research may be used to update the lead entry in the program database or other suitable database in step 408, thereby increasing the value or quality of the lead, and/or may be used to add one or more additional lead entries to the program database that are associated with the buyer and which could have relatively increased influence or impact on the buyer's purchasing decisions than did the initial lead. Additionally, the updated lead entry may then be sent back through triage and/or any additional entries may be sent through triage, described above, or such leads may be sent directly to a particular lead pursuit effort, such as the lead pursuit effort referred to herein as moment of interest marketing 114, which will be described in further detail below. Of course, other lead pursuit efforts may be utilized, and the present disclosure is not limited to only the example lead pursuit effort described herein.

In an additional or alternative but similar process, certain leads that do not pass triage may be sent to a research and repair process 113. In certain embodiments, triage 104 may fail certain leads because of certain exceptions that applied operating to kick the lead out of triage. The research and repair process may operate to involve researching the lead to provide additional information about the lead in order to remove the exception that caused the lead to fail triage 104. As discussed with respect to the optimization process 112, additional information may be pulled from a variety of readily-available resources, such as but not limited to, by using readily available research tools 406, such as but not limited to, free or subscription web-available applications or services like LinkedIn, Dunn & Bradstreet, InsideView, Google, or the like. In some embodiments, the research and repair process 113 may be automated, for example, through the use of web crawlers or other automated research tools, however such automation is not required. Where the exception(s) for a lead are removed, the updated lead entry may then be sent back through triage and/or may be sent directly to a particular lead pursuit effort, such as the lead pursuit effort referred to herein as moment of interest marketing 114, which will be described in further detail below. Of course, other lead pursuit efforts may be utilized, and the present disclosure is not limited to only the example lead pursuit effort described herein.

In still an additional or alternative process, certain leads that do not pass triage may be sent to a failed triage queue 115. The failed triage queue 115 may store failed leads for looking further into under one or more post-triage processes, such as the optimization 112 or research and repair 113 processes described above, and/or for generally storing the failed leads, possibly for later reconsideration.

With reference back to FIG. 1, as stated above, account pursuit rules 108 may define that a lead be automatically sent to a particular lead pursuit effort, such as moment of interest marketing or follow-up 114. As may be seen from the schematic illustration in FIG. 1, and as described in detail above, a lead may be sent to moment of interest marketing 114 automatically after triage 104 and/or optimization 112 or some other intelligent account pursuit process. In one embodiment, illustrated schematically in FIG. 5, moment of interest marketing 114 may comprise an intelligent system and method for pursuing leads passed thereto. In one embodiment of moment of interest marketing 114, each lead 502 may be initially entered into a calling queue 504, whereat it may be attempted to reach or otherwise contact the lead during a predetermined period of time. In some embodiments, the predetermined period of time may be 24 hours; however, other any suitable durations of time may be used for the initial predetermined period. From the moment of interest calling queues 504, leads that have not been reached in the initial predetermined period may be sent to the next step of moment of interest marketing 114, involving an active pursuit of the lead 116. In one embodiment, the active pursuit 116 may be a communication cycle where the lead is actively pursued on a daily basis. However, in other embodiments, any periodic communication cycle may be used, and is not limited to a daily basis. In one embodiment, the communication cycle may be pursued for a period of, for example, ten days. However, the period of active pursuit 116 during moment of interest marketing 114 may be any lesser or greater period of time. The ten day cycle of daily communications described herein is just one embodiment, and is not meant to limit the various embodiments of the present disclosure. For example, the cycle period may be determined by the user or user company and, in some embodiments, may depend, for example, on how commoditized the product may be. Generally, the more commoditized a product is, the shorter the period should desirably be. However, such rule of thumb is not required nor intended to be a limitation herein.

The cycle of communications, such as the ten day cycle mentioned above, may be performed using any suitable means of communication, such as but not limited to telephonic communication, electronic communications, such as email, etc., or any combinations thereof. In one embodiment, illustrated in FIGS. 5 and 6, the cycle of communications may be a predetermined combination of telephonic and electronic communications. For example, as shown in FIGS. 5 and 6, for any given lead in a calling queue 504, an initial telephonic communication 602 may be attempted in order to contact the lead and gauge the level of interest of the lead or the influence of the lead on purchasing decisions, and/or to otherwise try to turn the lead into a sale. If at any point during the communication cycle, the lead is contacted and is a relevant decision maker or is otherwise a qualified lead (e.g., a MQL) 604, then the period of active pursuit 116 may be ended and the lead turned over to sales 606. A qualified lead, among other conventional understandings of the phrase, may generally refer to a lead that has indicated interest in the user company's products or services or otherwise appears to be interested enough to warrant attempting further communication therewith. If at any point during the communication cycle, the lead is contacted but is not a relevant decision maker or is otherwise not a qualified lead 608, then the lead may be sent to an intelligent lead nurturing campaign 610 (also see FIG. 1), described in further detail below, where, for example, the lead may be nurtured, if possible, to provide information that would lead to a relevant decision maker for the account or otherwise provide additional information that may be utilized to market to the account. If the lead has no such ability or refuses to provide any additional information, then the lead may sent through lead reconstitution 118, where the lead may be sent back and reconstituted in future outbound lead generating campaigns.

If the lead is not contacted during the initial telephonic communication 602, similar telephonic attempts 612 may be subsequently attempted on, for example, a periodic cycle, such as on a daily basis for a predetermined number of days, such as days 2-4 of the ten day cycle mentioned above, until the lead is contacted. If the lead is still not reached, then a different type of communication, such as an email communication 614, may be attempted, for example, on day 5 of the ten day cycle. If the email communication 614 is successful in reaching out to the lead, the lead may be turned over to sales 606 and/or one or more subsequent attempts to reach the lead via telephonic communications may be attempted in order to solidify the lead. Whether the lead is routed for solidification via telephonic communications or the lead has still not been contacted following the email communication, additional telephonic attempts 616 may be attempted on, for example, a periodic cycle, such as on a daily basis for a predetermined number of days, such as days 6-8 of the ten day cycle mentioned above, until the lead is contacted. If the lead is still not reached after the second round of telephonic communications 616, then, once again, a different type of communication, such as an email communication 618, may be attempted, for example, on day 9 of the ten day cycle. If the email communication 618 is successful in reaching out to the lead, the lead may be turned over to sales 606 and/or one or more subsequent attempts to reach the lead via telephonic communications may be attempted in order to solidify the lead. At the end of the predetermined communication cycle, such as on day 10 of the ten day cycle, the active pursuit 116 may be stopped, and if the lead has not yet been contacted, the lead may be sent to the intelligent lead nurturing campaign 610, described in further detail below, where the lead may be nurtured, if possible, to provide information that would lead to a relevant decision maker for the account or otherwise provide additional information that may be utilized to market to the account.

In one embodiment, any one or more of the above described attempts at communicating with a lead, such as via an email communication 614, may include one or more data-driven elements 615, which may reinvigorate the lead. The data-driven element 615 may be any type of content, or digital links (e.g., web hyperlink) to content, from any suitable source. In one embodiment, a data-driven element 615 may be Internet or other digital content, or digital links thereto, which may be obtained from any suitable source. For example only, a data-driven element 615 may be: an article retrieved from a website or a link thereto; audio or video content or a link thereto; an image or a link thereto; and the like. Data-driven elements are not limited, however, to solely those examples provided herein. The data-driven elements 615 may be user or user company controlled and/or may be user or user company defined content. A data-driven element 615 for inclusion in a communication attempt with a lead may be selected from a library 617 of data-driven elements containing the content or links through which the content may be retrieved.

In some embodiments, history may be tracked for any given lead, including what action caused the lead to, for example, become a raw lead and/or pass triage. In this regard, a given lead's history may be utilized to select the data-driven element(s) 615 to be included in a communication for that lead so as to recreate and/or reinvigorate the lead's initial interest(s) in the user company and/or its product(s). In some embodiments, an alert may be generated when such a data-driven element or content is accessed by the lead. The access by a given lead may increase or otherwise change that lead's value and/or priority during the moment of interest marketing and/or generally within the systems or methods of lead nurturing described herein.

If the lead is contacted during the initial telephonic communication 602 or any subsequent telephonic communications, but is not interested, then in one embodiment, the lead may be held without contact until a subsequent day prior to the termination of the communication cycle where a final communication, such as an email communication 620, may be attempted to revitalize the lead prior to completing active pursuit 116. In some embodiments, the lead may be sent to the intelligent lead nurturing campaign 610 and/or lead reconstitution 118.

If the lead is contacted during the initial telephonic communication 602 or any subsequent telephonic communications, but the lead has provided a new lead for a decision maker, then in one embodiment, the new lead may be sent back through triage and/or acted on based on the account pursuit rules and the original lead may be routed directly to email communication 614 of the ten day cycle for continued marketing efforts.

In some cases, based on the outcome of an initial or subsequent contact with the lead, a telephone representative of the user company, for example, may take manual control 622 of the active pursuit 116. And in other cases, such as where during an initial or subsequent contact with the lead, the lead requests not to be contacted, the active pursuit 116 may be immediately terminated 624.

In one embodiment, if after the active pursuit cycle during moment of interest marketing, there has been no contact with a lead, the lead may be sent to an intelligent lead nurturing campaign 610. In one embodiment, a lead nurturing campaign may include what are referred to herein as predefined queues for accepting and/or receiving leads entering intelligent lead nurturing. Predefined queues may be user or user company defined queues, each based on one or more characteristic or attribute relating to the lead. For example only, the definition for a predefined queue may be based on: the revenue of the lead's company; the size of the lead's company; whether the lead tends to respond more often by email; whether the lead, by the nature of the lead's position in its company, should be sent directly to the user company's sales team; or any other suitable characteristic or attribute that may distinguish leads from one another. In one embodiment, the predefined queues utilized in an intelligent lead nurturing campaign 610 may be automated communication queues that send one or more automatic communications to a lead in that queue. For example, predefined queues may send an automated telephone call to a lead and/or send an automatically generated email to the lead. Of course any other suitable automated communication may be used, and predefined queues are not limited to only use of automated telephone calls and automatically generated emails. The content of the automated communications may vary from predefined queue to predefined queue. Furthermore, any particular lead may be accepted by or sent to one or more of the predefined queues. In one embodiment, if a lead in a predefined queue reacts to an automatic communication or otherwise re-indicates an interest in the user or user company, the reinvigorated lead may be sent back through triage and/or acted on based on the account pursuit rules.

With reference back to FIG. 1, and supported in FIG. 7, a system and method for capturing and developing market leads 100 of the present disclosure may additionally include a qualified lead pass-back system or method 120, which may generally revitalize stale qualified leads. Specifically, the qualified lead pass-back system 120 may automatically retrieve stale or inactive qualified leads 702 from an existing customer relationship management system 704. A qualified lead may become a stale or inactive qualified lead if, for example, at one point in time the lead was determined to be a qualified lead, such as but not limited to, by showing interest during a previous cycle of active pursuit 116, but the qualified lead has not transitioned to a state beyond a qualified lead, such as to a sales accepted lead (SAL). However, any method of defining a stale or inactive MQL may be utilized. The qualified lead pass-back system 120 may perform an analysis 706 of the inactive qualified lead 702, and based on the analysis may reinitiate the lead by routing the lead through any of the various processes described above, such as triage, lead nurturing, or lead reconstitution. In one embodiment, as it has already been determined that the lead is a qualified lead, the lead may be reinitiated by routing to active pursuit 116.

With reference now to FIGS. 8A-E, a system and method for capturing and developing market leads 100 of the present disclosure may provide various front-end facing interfaces for interacting with the automated flow of the system and/or for viewing or analyzing results at various stages of the process. The interfaces in some embodiments may be localized interfaces, while in other embodiments, the interfaces may be network ready and accessible, for example, over the Internet. For example, FIG. 8A illustrates one example interface for the user company to create, modify, delete, or view the TAM definition, including account definitions 204 and/or contact definitions 206, and to define, modify, delete, or view account pursuit rules 108. FIG. 8B-D illustrate example interfaces relating to triage and optimization, and may permit, for example, any number of actions or reports to be created or viewed relating to triaged leads, and permit information for any given lead discovered during optimization to be entered, modified, or viewed. FIG. 8E illustrates one example interface providing a dashboard overview of the pursuit efforts, such as moment of interest marketing and active pursuit, being undertaken. For example, the interface of FIG. 8E may provide a dashboard overview of the moment of interest callback queues, the upcoming calls for a given day or other cycle period, and the results of such active pursuit. Of course, the system and method for capturing and developing market leads 100 of the present disclosure is not limited to solely the interfaces described herein, nor must it include the interfaces described herein. Any number and combination of interfaces may be provided that permit a user company to implement the system and methods for capturing and developing market leads 100 of the present disclosure and/or to view metrics relating to the use of such systems and methods.

In some embodiment, historical lead interactions related to developing a raw lead into a qualified lead may be tracked and/or accumulated. The results of the tracking and/or accumulation of historical lead interactions may, in some embodiments, be the basis for or otherwise translated to a report, generally providing information about the “life” of the lead. Such a report can assist a B2B sales representative, by illustrating, for example, the complete history and life-cycle of a raw lead developing into a qualified sales-ready lead. The report may be automatically generated and may be displayed through one of the various front-end facing interfaces, described above, and/or may be automatically emailed to the appropriate sales representative(s). In other embodiments, the report may be generated and delivered to the appropriate sales representative(s) in any suitable manner. Such a report may provide information, for example, as to what communication methods and/or what other lead pursuit methods or mechanisms have worked best historically to develop any given raw lead to a qualified lead.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method for capturing and developing marketing leads, the method comprising:
storing, in a computer-readable storage medium, an addressable market definition comprising at least one of a definition for a desirable account type and a definition for a desirable contact type, and storing, in a computer-readable storage medium, an account pursuit rule defining an action to be pursued for a marketing lead;
with an electronic processor having access to the computer-readable storage medium, automatically applying the addressable market definition to a given lead during a triage process to determine whether the lead falls within the addressable market definition; and
where the lead falls within the addressable market definition, routing the lead to an active pursuit process comprising placing marketing leads in an automatically controlled communication cycle queue controlled by the electronic processor, the controlled communication cycle queue acting in accordance with a predetermined plan of lead pursuit and driving when communication attempts should be made to the marketing leads.

2. The method of claim 1, wherein a desirable account type is defined by one or more attributes characterizing a desirable account.

3. The method of claim 1, wherein a desirable contact type is defined by one or more attributes characterizing a contact person as a desirable contact.

4. The method of claim 3, wherein one attribute characterizing a contact person as a desirable contact is the contact person's employee role within a company.

5. The method of claim 1, wherein the lead is a raw lead derived from higher level hand-raising activity of the raw lead comprising at least one of the raw lead's viewing of a website or portion thereof and the raw lead's viewing or electronic download of multimedia content.

6. The method of claim 3, further comprising where the lead does not fall within the addressable market definition, routing the lead to a lead optimization process for determining additional information about the lead.

7. The method of claim 6, wherein additional information about the lead is derived from a web-accessible database.

8. The method of claim 6, further comprising routing the lead, with additional information, to the active pursuit process.

9. The method of claim 1, wherein the automatically controlled communication cycle queue drives communication attempts through a combination of communication means.

10. The method of claim 9, wherein the combination of communication means comprises a telephone communication and an email communication.

11. The method of claim 9, wherein the automatically controlled communication cycle queue lasts for a predetermined period of time.

12. The method of claim 11, further comprising including a digital multimedia element in at least one of the communication means.

13. The method of claim 12, wherein the digital multimedia element is selected from a library of digital multimedia content, the selection of the digital multimedia element based on which lead the digital multimedia element is to be sent.

14. The method of claim 11, further comprising, at or after the conclusion of the predetermined period of time, routing the lead to a nurturing campaign comprising placing the lead in a predefined queue, the predefined queue defined by a lead characteristic with which at least one attribute of the lead corresponds.

15. The method of claim 14, wherein the predefined queue is an at least partly automated communication queue that sends an automatic communication to the lead.

16. The method of claim 1, wherein the electronic processor further automatically tracks historical interactions with the lead and provides an electronic report based on the tracked historical interactions.

17. A system for capturing and developing marketing leads, the system comprising:
a computer-readable storage medium storing an addressable market definition defining one or more attributes for a desirable marketing lead type and storing an account pursuit rule defining an action to be pursued for a given marketing lead;
an electronic processor communicatively coupled with the computer-readable storage medium, the electronic processor applying the addressable market definition to a given lead during a triage process to determine whether the lead falls within the addressable market definition, and where the lead falls within the addressable market definition, routing the lead to an active pursuit process comprising placing marketing leads in an automatically controlled communication cycle queue, the controlled communication cycle queue acting in accordance with a predetermined plan of lead pursuit and driving when communication attempts should be made to the marketing leads; and
a user interface, provided by the electronic processor, and configured for display on an electronic display communicatively coupled with the electronic processor via an electronic network.

18. The system of claim 17, wherein the automatically controlled communication cycle queue drives communication attempts through a combination of communication means and lasts for a predetermined period of time.

19. The system of claim 18, wherein at least one of the communication means comprising a digital multimedia element, wherein the digital multimedia element is selected from a library of digital multimedia content, the selection of the digital multimedia element based on which marketing lead the digital multimedia element is to be sent.

20. The system of claim 18, wherein, at or after the conclusion of the predetermined period of time, the electronic processor routes the lead to a predefined queue, the predefined queue is defined by a lead characteristic with which at least one attribute of the lead corresponds and is an at least partly automated communication queue that sends an automatic communication to the lead.
